(19) United States
(12) Patent Application Publication
(10) Pub. No.: US 2019/0047139 A1
(43) Pub. Date: Feb. 14, 2019

(54) SUPPORT RAIL FOR A ROBOT PLATFORM THAT IS DISPLACEABLE IN A TRANSLATORY MANNER, AND DISPLACEMENT SYSTEM AND ROBOT SYSTEM HAVING SUCH A SUPPORT RAIL

(71) Applicants: Fredy DOLL, Achern (DE); Thomas KOLLMAR, Flein (DE)

(72) Inventors: Fredy DOLL, Achern (DE); Thomas KOLLMAR, Flein (DE)

(21) Appl. No.: 15/896,451

(22) Filed: Feb. 14, 2018

(30) Foreign Application Priority Data
Aug. 11, 2017 (EP) 17185997.8

(51) Int. Cl. B25J 5/04; B25J 9/02; B61B 13/04; E01B 1/00; E01B 5/08; E01B 25/10; B66C 7/08

(52) U.S. Cl. CPC B25J 5/04; B25J 9/026; B61B 13/04; B66C 7/08; E01B 5/08; E01B 25/10; E01B 1/004

(57) ABSTRACT

A support rail for a robot platform displaceable in a translatory manner. This support rail is configured in the manner of an elongate construction element having at least one metallic guide rail for guiding the robot platform, the metallic guide rail being provided on the external side and extending in a main direction of extent. The support rail has at least one lower metallic connection flange for fastening the support rail on a sub-base such as a shed floor or to a gantry base, and on an external side, has at least one upper metallic connection flange for attaching the metallic guide rail and/or directly the at least one metallic guide rail. The support rail is designed having a support structure of concrete, and the support rail has a metallic tension structure embedded in the support structure of concrete and under tensile stress in the main direction of extent.

### CROSS-REFERENCE TO RELATED APPLICATIONS

This claims priority from European Application No. 17185997.8, filed on Aug. 11, 2017, the disclosure of which is hereby incorporated by reference in its entirety.

### FIELD OF APPLICATION AND PRIOR ART

The invention relates to a support rail for a robot platform that is displaceable in a translatory manner, according to the preamble of Claim 1, and to a gantry base for a robot system, according to the preamble of Claim 8. The invention furthermore relates to a displacement system having such a support rail including the robot platform, and to a robot system having such a support rail. The invention moreover relates to methods for the production of a support rail according to the invention.

Generic support rails are known in general from the prior art. These support rails which are sometimes also referred to as the seventh axis or the travel axis, serve the purpose of displacing a conventional industrial robot in a horizontal translatory manner by means of the robot platform that is attached so as to be displaceable in a translatory manner on said support rails. The demand therefor exists in many industrial fields of application, for example in manufacturing when the robot is to be employed at various locations, or in cases in which the robot according to the intended use is to be able to autonomously approach a workpiece storage in order to acquire therein a workpiece to be installed.

Support rails of the generic type are usually fastened to a sub-base by means of a connection flange on the floor, in particular on a shed floor or on a gantry base, by means of which the support rails are positioned significantly above a shed floor or preferably at a height of at least 1.50 m. Support rails of the generic type, on the upper side thereof, usually have two guide rails that run parallel so as to be mutually spaced apart, the wheels of the displaceable robot platform rolling on said guide rails.

Known support rails are configured as completely metallic support rails, in most instances from aluminium or steel. This leads to a comparatively high price of the support rails.

A gantry base of the generic type serves the purpose of providing a support rail of the generic type in an elevated position, preferably at least 1.50 m above a shed floor. There is thus space, for example for further machines, remaining below the support rail and the robot that is displaceable thereon. The use of such a gantry construction mode can also be expedient when the operating steps that are to be carried out by the robot are ideally carried out from above.

### OBJECT AND ACHIEVEMENT

It is an object of the invention, in particular for the application in the case of a robot system in a gantry construction mode, to provide a comparatively cost-effective and technically advantageous construction type of a support rail, in particular for use on a gantry base, and a cost-effective and technically advantageous construction type of a gantry base.

A support rail for a robot platform that is displaceable in a translatory manner is proposed according to the invention. Said support rail in a known way is configured in the manner of an elongate construction element that is aligned in a main direction of extent, having at least one metallic guide rail for guiding the robot platform, said metallic guide rail being provided on the external side and extending in the main direction of extent. The support rail in a downwards pointing part-portion has at least one lower metallic connection flange for fastening the support rail to a sub-base such as a shed floor or to a gantry base. Opposite thereto, the support rail in an upwards pointing part-portion, on an external side, has at least one upper metallic connection flange for attaching the metallic guide rail and/or directly the at least one metallic guide rail.

“Down” and “up” in this context relates to the coordinate system of the support rail and does not necessarily mean that the lower connection flange must be aligned towards the floor but in the direction of an attachment face which indeed in most instances is a horizontal floor area, but can also be a gantry base, for example, on which the support rail can be secured by way of a lower connection flange that points to the side or even upwards.

It is provided according to the invention in the case of a support rail of the type described, that said support rail has a support structure of concrete. A metallic tension structure which is under tensile stress in the main direction of extent is provided so as to be embedded in said support structure of concrete. The tension structure extends across at least 60%, preferably across at least 80%, of the length of the support structure.

The metallic tension structure that is embedded in the support structure has been demonstrated to be very advantageous in preventing a robot platform that is displaceable along the support rail, by virtue of the load of said robot platform, from leading to an inacceptably severe flexing. While such flexing is in most cases not to be anticipated in the case of a support rail that by way of floor plates at a minor spacing is provided directly on the floor, a significantly larger spacing between supports such as, for example, columns of the gantry base, is usually provided in the use of support rails on a gantry base, such that the risk of flexing under load mentioned is presently high. The longer the support rail, or the spacing of the supports thereof, respectively, the more expedient the use of a metallic tension structure. A support rail according to the invention preferably in the main direction of extent has a length of at least 3 m, in particular between 4 m and 8 m, particularly preferably of approximately 6 m. The support rail is particularly preferably supported only at the two opposite ends, in particular by the columns of a gantry base.

However, such a deformation is significantly reduced by a tension structure that is under tensile stress. The forces that act externally on the support rail are introduced into the tension structure either by a direct metallic connection between the internal structure and the connection flanges of the support rail, or by way of the support member of concrete. The support structure of concrete per se and/or another part of the support rail are under compressive stress. It is also this compressive stress that reduces the flexing of the support rail. The compressive stress which is introduced into the concrete by the tension structure is preferably sufficiently intense so that the concrete under normal loads at all times remains under compressive stress and is not subjected to tensile stress.

A design in which the support rail additionally has a metallic compression structure that in the main direction of extent is under compressive stress is furthermore possible. It is particularly preferred herein for the compression structure to have an external structure that forms external faces of the support rail, said external structure being particularly preferably formed by a hollow section.

In the case of such a design, a metallic connection exists between the compression structure and the tension structure such that the tensile forces on the tension structure are at least partially equalized by the compressive forces on the compression structure. This metallic connection is preferably provided at the two opposite ends of the support rail. The compression structure can preferably be present in the form of the hollow section mentioned, but instead can also be present in the form of a compression structure that is embedded in the support structure. The external structure in the form of a hollow section that functions as the compression structure, by way of the opposite ends thereof, forms quasi anchor points for the tension structure.

A substantial advantage of such a design having a compression structure lies in that the as yet unfinished support rail in the course of the production does not have to remain in a production tool until the concrete has sufficiently cured in order to be able to sustain the compressive forces that are coupled thereinto by the tension structure.

This comprises designs in which the metallic connection, preferably at the end sides, of the metallic tension structure to the metallic compression structure is provided in a permanent manner. Alternatively however, it can also be provided that the connection between the inboard tension structure and the compression structure exists only temporarily and in the case of an interim product in the course of the production, such that the curing of the concrete can take place outside of a tool that maintains the tensile stress. The connection can then be removed after curing, such that the cured concrete on account thereof is put under compressive stress.

The tension structure can be formed by simple rods of a uniform cross-section that are placed in the main direction of extent and that maintain the stress thereof in a force-fitting manner solely on account of the bonding of the concrete to the external side of the rods.

A design in which the tension structure is configured in such a manner that said tension structure interacts with the support structure of concrete transversely to the main direction of extent, and in relation to the main direction of extent interacts with the support structure of concrete in a form-fitting manner, is advantageous. The regions of the form-fitting interaction between the support structure and the tension structure form quasi anchor points for the tension structure. One possibility therefor lies in that the tension structure at both end sides can be connected to compression plates extended transversely to the main direction of extent. Alternatively or additionally, the tension structure in relation to the main direction of extent can have a variable cross-section, for example on account of transverse struts welded thereto, or of other shapes that impart an anchoring effect.

The support structure of a support rail according to the invention is composed of concrete. It has been demonstrated that concrete has very advantageous properties, in particular damping properties. In order to have low requirements in terms of the complexity of the production, normal construction concrete/cement concrete can be used. However, depending on the requirements, it can also be advantageous for polymer concrete to be used. The stability can be additionally enhanced by additionally incorporating a fibrous material, for example in the form of nets or mats. In this case, the support structure is one from textile concrete.

The invention furthermore relates to a displacement system for a robot, having a support rail having at least one guide rail provided thereon, and a robot platform which is displaceable along the support rail. The support rail herein is configured in the manner as described above.

The invention furthermore also relates to a gantry base of a robot system, for attaching a support rail for a robot platform that is displaceable in a translatory manner. This gantry base has a plurality of vertically extended gantry columns. Said gantry columns have in each case at least one lower metallic connection flange for fastening the gantry columns to a sub-base such as a shed floor, and at least one upper connection flange for attaching a horizontally extended support rail for a robot platform that is displaceable in a translatory manner.

According to the invention it is provided that at least one of the gantry columns has a metallic external structure which is formed by a metallic hollow section. An internal region that is surrounded by this hollow section is at least largely filled with concrete. A metallic internal structure is furthermore embedded in the concrete in the internal region.

Such a gantry column having a metallic internal structure which is embedded in the concrete has proven advantageous in terms of damping properties and stability. The internal structure moreover permits a hollow section having a comparatively minor wall thickness of, for example, at maximum 12 mm or at maximum 8 mm, to be used. The metallic internal structure preferably extends across at least 60% of the length, in particular across at least 80% of the length, of the hollow section.

The metallic internal structure can be embedded completely in the concrete such that each transmission of external force to the internal structure is performed by way of the concrete. A design in which the metallic internal structure is connected directly to the hollow section, preferably by way of a welded connection or a screw connection, is alterntively also possible, however.

In the case of a design having an internal structure that is only placed into the concrete and embedded completely by the latter, the production is performed in that the internal structure is temporarily, and preferably at the ends, positionally fixed relative to the hollow section while the concrete is filled into the hollow section so as to cure therein. This form of temporarily fixing the position can be dispensed with in the case of a direct connection.

The metallic internal structure can have at least one longitudinal segment that is aligned in the main direction of extent, and a plurality of transverse segments which in the transverse direction rise above the longitudinal segment. Said metallic internal structure can also have a plurality of longitudinal segments that are aligned in the main direction of extent and are interconnected by way of transverse segments. An internal structure of this type, having a complex and preferably cage-type geometry, improves the properties of a gantry column that is designed according to the invention.

The invention moreover also relates to a robot system having a gantry base of the type described, and/or a horizontal support rail of the type described, supported by the gantry base. The robot system preferably comprises a robot that is attached to the robot platform.

The invention furthermore relates to methods for the production of a support rail of the type described.

In the case of a first variant of the method for the production of a support rail of the type described above it is provided that at least one lower metallic connection flange and at least one upper metallic connection flange, or a guide rail, respectively, are placed into a formwork or onto the formwork. Furthermore, a tension structure is placed into the formwork and at the end sides secured in a locationally fixed manner to walls of the formwork such that said tension structure is under tensile stress acting in the main direction of extent of the formwork. The formwork is subsequently cast with concrete such that the support structure is formed on account thereof, wherein the tension structure while under tensile stress is embedded in the concrete of the support structure. The support rail produced on account thereof, after the concrete of the support structure has at least partially cured, is removed from the formwork, wherein the tensile stress in the tension structure is at least partially preserved.

It is accordingly provided in the case of such a method that the concrete cures partially or completely before the external tensile force that is applied by the tool is removed and, a compressive stress, in particular by way of the shaping of the tension structure that acts in the manner of an anchor on the support structure, is thus established in the concrete so as to maintain the tensile stress that is directed counter to the former in the tension structure.

In the case of an alternative method for the production of a support rail of the type described, it is provided that a combined metallic tension and compression structure which has at least one structural portion that is under tension in a main direction of extent, and at least one structural portion that is under compression in the main direction of extent is established. A support structure in which at least the structural portion that is under tension is embedded is subsequently cast from concrete.

This method permits the support rail which by virtue of the not yet cured concrete is as yet unfinished to be removed from the tool comparatively early after the support structure has been cast since the support rail by way of the compression structure can maintain the tensile stress in the tension structure in a self-acting manner.

In the case of a particular variant of the method it is provided that a separation of the tension structure from the compression structure is performed after the concrete of the support structure has at least partially cured, wherein the tensile stress in the tension structure is at least partially preserved. In the case of such a procedure, the compression structure supports the tensile stress that exists in the tension structure only in the course of the production. As soon as the concrete has sufficiently cured, the separation mentioned is performed such that the concrete is thus put under compressive stress.

### BRIEF DESCRIPTION OF THE DRAWINGS

Further advantages and aspects of the invention are derived from the claims and from the description hereunder of preferred exemplary embodiments of the invention which are explained hereunder by means of the figures in which:

FIG. 1 shows a robot system using a support rail according to the invention;

FIG. 2 shows the support rail of the robot system including add-on parts;

FIGS. 3A and 3B highlight a first possibility for constructing a support rail according to FIG. 2;

FIGS. 4A and 4B highlight a second possibility for constructing a support rail according to FIG. 2;

FIGS. 5A and 5B highlight a third possibility for constructing a support rail according to FIG. 2;

FIGS. 6A to 6D in an exemplary manner highlight the production of a support rail according to FIG. 2 in various stages of the production;

FIG. 7 shows a construction of a support rail in the gantry construction mode, comprising a gantry base having a plurality of gantry columns;

FIGS. 8 and 9 highlight various possibilities for fastening a support rail to the gantry base.

### DETAILED DESCRIPTION OF THE EXEMPLARY EMBODIMENTS

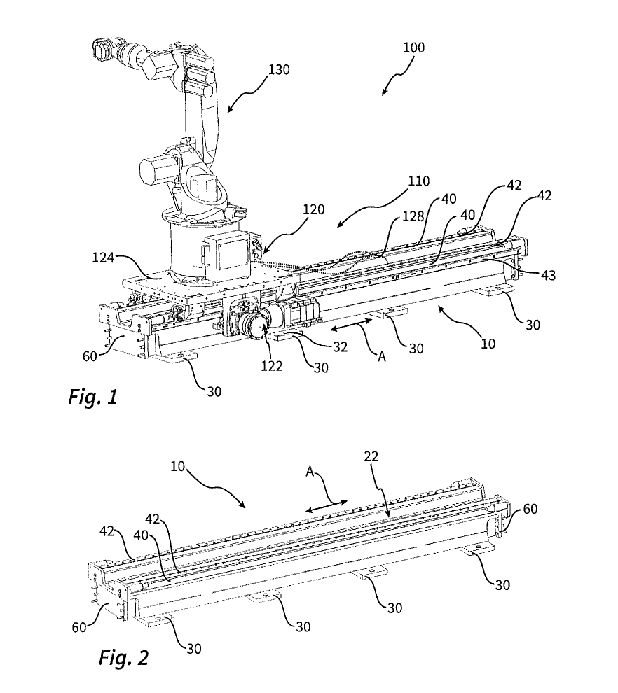

FIGS. 1 and 2 show a robot system 100 according to the invention, which can be used in particular in the course of production, and the support rail 10 of said robot system 100 in a separate view.

The robot system 100 has a displacement system 110 comprising the horizontally aligned support rail 10 mentioned and a platform 120 which on this support rail 10 is displaceable in the main direction of extent A of the support rail 10. The support rail 10, which is again illustrated separately in FIG. 2, on the lower side thereof has connection flanges 30 in the form of floor plates which are provided with bores 32 so as to be securely fastened to a sub-base, in particular to a shed floor or a gantry base that is provided to this end. Two parallel mutually spaced apart connection flanges 40 to which in each case one guide rail 42 is screw-fitted are provided on the upper side of the support rail 10. The platform 120 can be displaced on these guide rails, the platform 120 to this end having castors. Driving is performed by way of a motor 122 which drives a sprocket (not illustrated) which interacts with a rack of the support rail 10. Terminal detents for limiting the movability of the platform 120 are provided in each case on the end side of the support rail 10. An industrial robot 130 having robotic arms that are pivotable in multiple axes is provided on the upper side 124 of the platform 120.

By attaching the industrial robot 130 to the platform 120 the robot gains a further degree of freedom which can be utilized, for example, to reach processing locations that are further spaced apart, or to approach a storage so as to pick up components therefrom.

A line bundle 128 (illustrated with dashed lines) which is received in a trough-type channel 22 between the guide rails 42 is provided for supplying the platform 120 and the industrial robot 130.

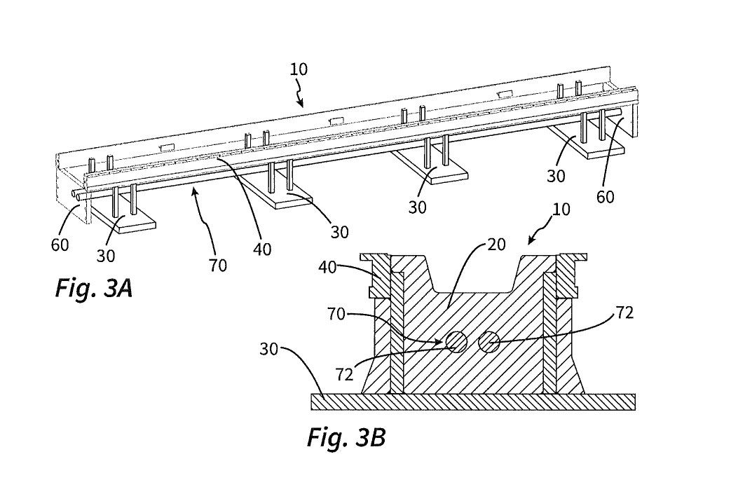

FIGS. 3A and 3B highlight the internal construction of a first variant of a support rail. The support structure 20 of concrete is omitted for the sake of clarity in FIG. 3A. It can be seen that a tension structure 70 which in an exemplary manner is presently formed by two tie rods 72 is embedded in the support structure 20. These tie rods 72 are fastened, for example screwed or welded, on the end sides to the compression plates 60 that serve as anchors for the bracing. The two tie rods 72 are under tensile stress and by way of the compression plates 60 introduce a corresponding compressive force into the support structure 20 of concrete. An enhanced stability of the support rail in terms of flexing is achieved on account thereof, such as is to be anticipated in particular in the case of a use in a robot system according to the gantry construction mode. Alternatively, this enhanced stability could indeed also be achieved by a larger cross section of the support structure 20. However, since it is provided according to the intended use that the support rails of the type according to the invention replace support rails that are typically produced from metal, in particular aluminium, it is desirable for the construction form of the support rail 10 to have a volume that is as similar as possible. This can be achieved by the tension structure 70.

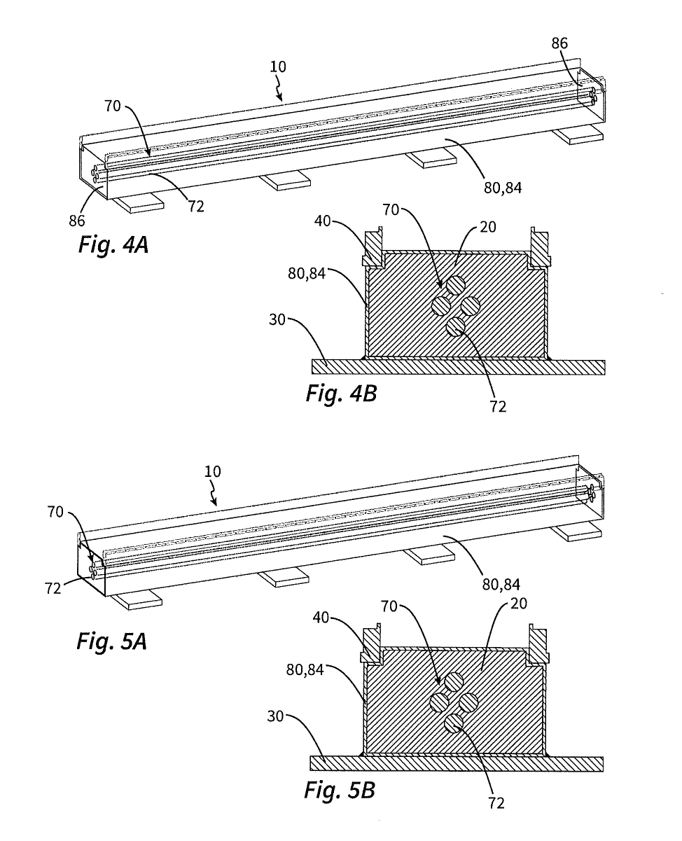

FIGS. 4A and 4B show a second design embodiment of a support rail 10 according to the invention. Said second design embodiment has the peculiarity that the former on the outer side is formed by a metallic hollow section, for example of aluminium or steel, which at both end sides is closed by metallic end faces 86. A tension structure 70 which is composed of tie rods 72 which internally are welded or screwed to the end sides 86 is again provided.

It is caused on account thereof that the tensile stress prevailing in the tension structure 70 does not have to be entirely and optionally not even largely absorbed by the support structure 20 of concrete, but can be absorbed by the hollow section 84. This is advantageous in the production since no external tool which maintains the tensile stress is blocked. Instead, this can be performed in a self-acting manner by the support rail by way of the end faces 86 thereof.

It is provided in the design according to FIGS. 4A and 4B that the end faces 86 are permanently preserved and thus that at least part of the compressive stress for compensating the tensile stress in the tension structure 70 is permanently made available by the hollow section 84.

The fundamental construction in the case of the alternative design according to FIGS. 5A and 5B is identical. However, no end faces 86 are provided here so that no metallic connection exists between the tension structure 72 and the hollow section 84. This means that the tensile stress of the tension structure 70 is introduced into the support structure 20 of concrete. However, it is advantageous also in a design according to FIGS. 5A and 5B for said design to be produced in the same manner as the design of FIGS. 4A and 4B, in that a metallic connection between the ends of the hollow section 84 and the ends of the tie rods of the tension structure 70 exists at the point of time of production. This metallic connection is released by severing the connection only after the concrete of the support structure 20 has cured, such that the support structure 20 of concrete is put under pressure at this moment in time.

The tension structure in FIGS. 5A and 5B is illustrated in such a manner that the former is composed of purely cylindrical metal rods 72. However, deviating therefrom, it can also be provided that the rods 72 are provided with thickenings that are aligned transversely to the direction of extent of said rods 72, said thickenings engaging in a form-fitting manner in the support structure and, on account thereof, providing anchor points for the tie rods 72.

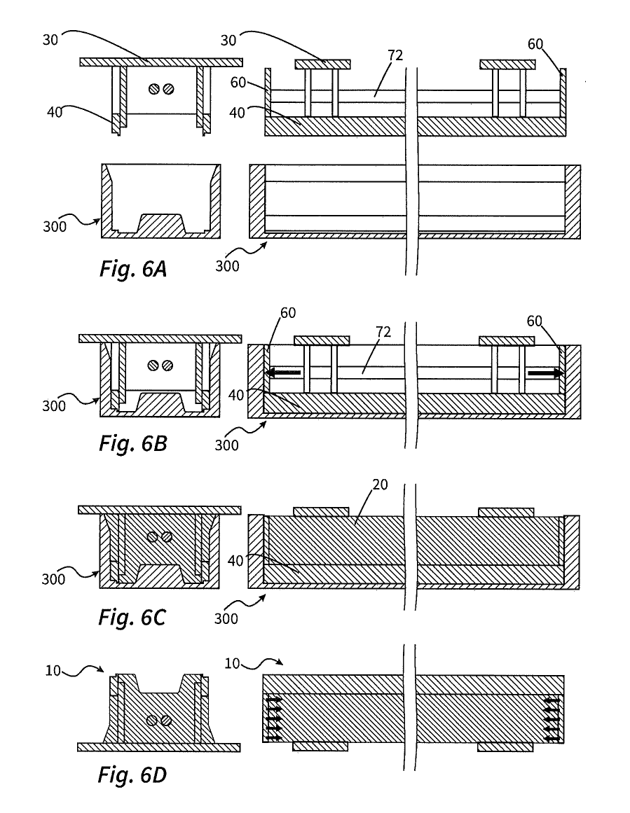

The manufacturing method for the production of the support rail according to FIGS. 3A and 3B will be explained in an exemplary and schematic manner by means of FIGS. 6A to 6E.

The starting point of the method is a formwork 300, illustrated in FIG. 6A, which in the way highlighted in FIG. 6B is placed in a multi-part metal framework which comprises inter alia the lower connection flanges 30 and the upper connection flanges 40 as well as connection struts therebetween. Moreover, the metal framework comprises the two compression plates 60 which are interconnected by the tie rods 72.

The compression plates in the manner highlighted by the arrows of FIG. 6B are pulled outwards by a tensile force that is applied by the tool such that the desired tensile stress is built up in the tie rods 72. In this state, the support structure 20 is then cast by supplying concrete such that the support structure 20 according to FIG. 6C is created.

The support rail 10 is removed from the formwork 300 as soon as the concrete has cured. The tensile stress existing in the tie rods 72, in the manner highlighted by the arrows in FIG. 6D, leads to a compressive stress in the support structure 20.

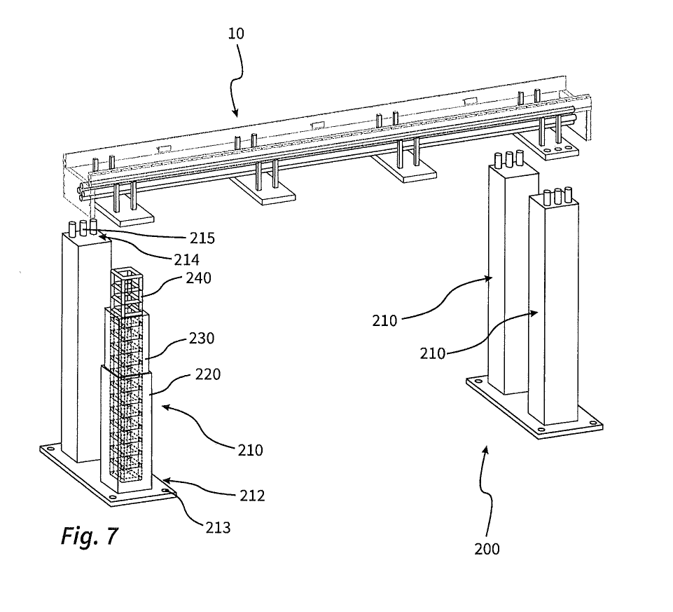

FIG. 7 shows a support rail 10 of the type described in the use as a support rail 10 of a robot system in a gantry construction mode. Therefore, apart from the support rail 10 mentioned, a gantry base 200 which comprises a plurality of gantry columns 210 which at the lower end thereof have a metallic connection flange 212 with fastening bores 213 for fastening to the shed floor and at the upper end thereof are in each case provided with one connection flange 214 which in the embodiment illustrated are configured by three threaded rods for fastening the lower connection flanges 30 of the support rail 10 is provided.

Since the support rail of a length of, for example, 3 m by virtue of the gantry construction mode is fundamentally at risk of flexing, the variant described, having a tention structure 70 with tie rods 72, is used.

Like the support rail 10, the gantry columns 210 of the gantry base 200 are also produced as a composite of concrete and metal. The gantry columns 210 have a metallic hollow section 220 which in an internal region is cast from concrete 230, wherein the concrete surrounds a metallic internal structure 240. It has been demonstrated that such a construction having a metallic hollow section and a metallic internal structure as well as a concrete core achieves optimal preconditions for effecting simultaneously the required stability and positive damping properties. Furthermore, the concrete and the metallic internal structure permit the use of hollow sections with comparatively thin walls.

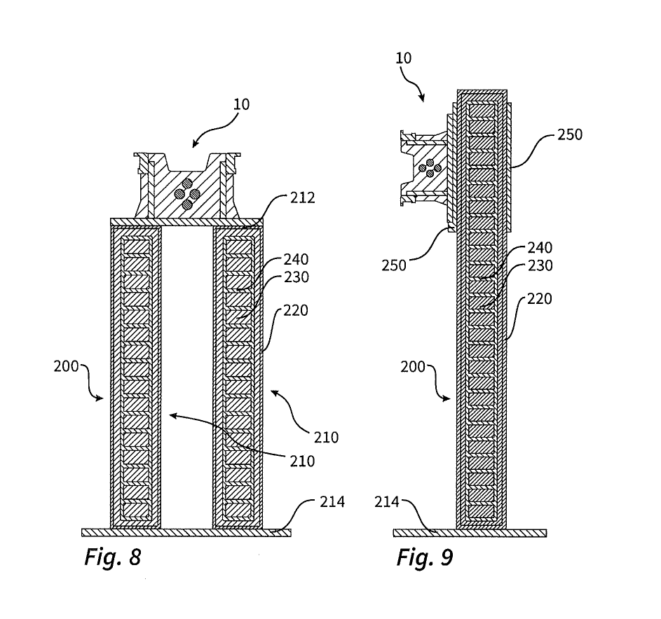

The system of FIG. 7 is also illustrated in a side view in FIG. 8 in which it can be seen what the gantry columns 210 look like in the cross section. Deviating from the variant illustrated, it is also possible for the metallic internal structure 240 to be connected directly to the respective hollow sections 220 by way of a welded connection or screw connection.

FIG. 9 shows that another alignment of the support rail 10 can also be expedient, depending on the specific field of application. In the case of the design embodiment of FIG. 9, metal plates 250 which are screwed together in a manner not illustrated in more detail are provided on both sides of the support column. The metal plate 250 on the left side is furthermore screwed to the lower connection flange 30 of the support rail 10.

1. Support rail for a robot platform that is displaceable in a translatory manner, having the following features:
a. the support rail is configured in the manner of an elongate construction element that is aligned in a main direction of extent, having at least one metallic guide rail for guiding the robot platform, said metallic guide rail being provided on the external side and extending in the main direction of extent;
b. the support rail in a downwards pointing part-portion has at least one lower metallic connection flange for fastening the support rail to a sub-base such as a shed floor or to a gantry base;
c. the support rail in an upwards pointing part-portion, on an external side, has at least one upper metallic connection flange for attaching the metallic guide rail and/or directly the at least one metallic guide rail;
d. the support rail has a support structure of concrete; and
e. the support rail has a metallic tension structure that is embedded in the support structure of concrete and is under tensile stress in the main direction of extent (A).

2. Support rail according to claim 1, having the following additional feature:
a. the support rail has a metallic compression structure that in the main direction of extent (A) is under compressive stress.

3. Support rail according to claim 2, having the following additional feature:
a. the compression structure has an external structure that forms the external face of the support rail;
in particular having the following additional feature:
b. the external compression structure is formed by a hollow section.

4. Support rail according to claim 2, having the following additional feature:
a. the tension structure extends across at least 60%, preferably across at least 80%, of the length of the support structure.

5. Support rail according to claim 1, having the following additional feature:
a. the tension structure at both end sides is connected to compression plates extended transversely to the main direction of extent (A); and/or
c. the tension structure in relation to the main direction of extent has a variable cross-section.

6. Support rail for a robot platform that is displaceable in a translatory manner, according to claim 1, having at least one of the following additional features:
a. the support structure is produced from cement concrete or from polymer concrete; and/or
b. the support structure is produced from textile concrete; and/or
c. in order for the mass to be reduced, at least one void is provided, or at least one block from plastic, in particular from polystyrene, is incorporated, in the concrete of the support structure; and/or
d. the at least one lower metallic connection flange is formed by at least one floor plate which for attaching to the sub-base has bores, wherein a plurality of mutually spaced apart floor plates are preferably provided; and/or
e. the support rail in the main direction of extent has a length of at least 3 m, in particular of at least 6 m.

7. Displacement system for a robot, having the following features:
a. the displacement system has at least one support rail having at least one guide rail provided thereon;
b. the displacement system has at least one robot platform on which a robot is disposed according to the intended use; and
c. the support rail is configured according to claim 1.

8. Gantry base of a robot system, for attaching a support rail for a robot platform that is displaceable in a translatory manner, having the following features:
a. the gantry base has a plurality of gantry columns;
b. the gantry columns have at least one lower metallic connection flange for fastening the gantry columns to a sub-base such as a shed floor;
c. the gantry columns has at least one upper connection flange for attaching a horizontally extended support rail for a robot platform that is displaceable in a translatory manner;
d. at least one gantry column has a metallic external structure which is formed by a metallic hollow section;
e. an internal region that is surrounded by the hollow section is at least largely filled with concrete; and
f. a metallic internal structure is embedded in the concrete in the internal region.

9. Gantry base according to claim 8, having at least one of the following additional features:
a. the metallic internal structure extends across at least 60% of the length, in particular across at least 80% of the length, of the hollow section; and/or
b. the metallic internal structure is connected directly to the hollow section, preferably by way of a welded connection.

10. Gantry base according to claim 8, having the following additional features:
a. the metallic internal structure has at least one longitudinal segment that is aligned in the main direction of extent, and a plurality of transverse segments which in the transverse direction rise above the longitudinal segment; and/or
b. the metallic internal structure has a plurality of longitudinal segments that are aligned in the main direction of extent and are interconnected by way of transverse segments.

11. Robot system having a gantry base and a horizontal support rail that is supported by the gantry base, having at least one of the following features:
a. the support rail is configured according to claim 1; and/or
b. the gantry base is configured according to claim 8.

12. Robot system according to claim 11, having the following additional feature:
a. the robot system comprises a robot that is attached to the robot platform.

13. Method for the production of a support rail for a robot platform that is displaceable in a translatory manner, according to claim 1, having the following features:
a. at least one lower metallic connection flange and at least one upper metallic connection flange, or a guide rail, respectively, are placed into a formwork or onto the formwork;
b. a tension structure is placed into the formwork and at the end sides secured in a locationally fixed manner to walls of the formwork such that said tension structure is under tensile stress acting in the main direction of extent (A) of the formwork;
c. the formwork is subsequently cast with concrete such that the support structure is formed on account thereof, wherein the tension structure while under tensile stress is embedded in the concrete of the support structure; and
d. the support rail produced on account thereof, after the concrete of the support structure has at least partially cured, is removed from the formwork, wherein the tensile stress in the tension structure is at least partially preserved.

14. Method for the production of a support rail for a robot platform that is displaceable in a translatory manner, according to claim 1, having the following features:
a. a combined metallic tensile and compressive structure which has at least one structural portion that is under tension in a main direction of extent (A), and at least one structural portion that is under compression in the main direction of extent (A) is established; and
b. a support structure in which at least the structural portion that is under tension is embedded is cast from concrete.

15. Method according to claim 14, having the following additional feature:
a. a separation of the tension structure from the compression structure is performed after the concrete of the support structure has at least partially cured, wherein the tensile stress in the tension structure is at least partially preserved.
